(19) United States
(12) Patent Application Publication
(10) Pub. No.: US 2002/0070292 A1
(43) Pub. Date: Jun. 13, 2002

(54) Cleaning liquid dispensing apparatus for a shower head

(76) Inventor: David S. Hazenfield, Mukwonago, WI (US)

Correspondence Address: Donald J. Ersler, 725 Garvens Avenue, Brookfield, WI, 53005, US

(21) Appl. No.: 09/993,998

(22) Filed: Nov. 6, 2001

Related U.S. Application Data
(60) Provisional application No. 60/247,462, filed on Nov. 10, 2000.

(51) Int. Cl. B05B 7/26

(52) U.S. Cl. 239/310

(57) ABSTRACT

A cleaning liquid dispensing apparatus includes at least one container having a pump, a fluid line, a check valve, and a 3-way connector. One end of the 3-way connector is attached to a shower head pipe, an opposing end is attached to a shower head, and a remaining end is attached to one end of a fluid line. The one end of the fluid line is terminated with the check valve. The other end of the fluid line is attached to a container having a pump. If more than one container having a pump is connected to the 3-way connector; a splitter connector is connected between the 3-way connector and fluid lines. The container having a pump is filled with a cleaning liquid such as soap or shampoo. To inject the cleaning liquid into the shower stream, a push button of the pump is actuated several times until cleaning fluid in the bottle is displaced into the stream of the shower.

### Cross-References to Related Applications This is a utility application taking priority from provisional patent application, Ser. No. 60/247,462 filed on Nov. 10, 2000.

### BACKGROUND OF THE INVENTION

1. Field of the Invention

The present invention relates generally to injecting a cleaning fluid into a shower head and more specifically to a cleaning liquid dispensing apparatus for a shower head which allows a cleaning liquid to be inserted into a water stream in a shower.

2. Discussion of the Prior Art

There are numerous devices which address the issue of combining a cleaning liquid with the flow of water through a shower head. Some of these devices are described in U.S. Pat. No. 2,316,781 to Fox, U.S. Pat. No. 4,218,013 to Davison, U.S. Pat. No. 4,651,930 to Magaha, Jr., U.S. Pat. No. 4,901,765 to Poe, and U.S. Pat. No. 6,041,971 to Pineda. However, none of these devices describe the use of a container having a manual pump to inject a cleaning liquid into a water stream in a shower head.

Accordingly, there is a clearly felt need in the art for a cleaning liquid dispensing apparatus for a shower head which allows a cleaning liquid to be inserted into a shower stream with a manual pump; which has a container that is low enough to allow a child to operate thereof; and which has a construction that is less complicated than that of the prior art.

### SUMMARY OF THE INVENTION

The present invention provides a cleaning liquid dispensing apparatus for a shower head which has a less complicated construction than that of the prior art. The cleaning liquid dispensing apparatus includes at least one container having a pump, a fluid line, a check valve, and a 3-way connector. One end of the 3-way connector is sized to be threadable received by a shower head pipe, an opposing end is sized to be threadably received by a shower head, and a remaining end is sized to be attached to one end of a fluid line. One end of the fluid line is terminated with the check valve. The other end of the fluid line is attached to a single container having a pump. If more than one container having a pump is connected to the 3-way connector; a splitter connector is connected between the 3-way connector and fluid lines.

The container having a pump preferably includes a bottle, a fluid bag, and a manual pump. The manual pump includes a pump body, a push button assembly, and a check valve. The pump body includes an inlet, outlet, and button chamber. The check valve is attached to the inlet to prevent air from escaping from the pump body. The push button assembly is inserted into the button chamber. A pump opening is formed in a bottom of the bottle to receive the manual pump. The fluid bag may be inserted through the pump opening. A top of the fluid bag is attached to an inside neck of the bottle. The fluid bag is filled with a cleaning liquid such as soap or shampoo.

To inject the cleaning liquid into the shower stream, a push button of the push button assembly is actuated several times until a bottom of the bottle is filled with air. The air on the bottom of the bottle displaces the cleaning liquid in the fluid bag through the fluid tube and into the water stream in the shower head.

A second embodiment of a container having a pump preferably includes a bottle, a cap, a bulb pump, and a push button. The cap preferably snaps on to the bottle. A suction tube is disposed on one end of the bulb pump and a propulsion tube is disposed on the other end thereof. The bulb pump is retained in the cap. A button slot is formed in a wall of the cap which is sized to slidably receive the push button. When the push button is actuated against the pump bulb, a vacuum draws a quantity of liquid from a bottom of the bottle through the suction tube. The quantity of liquid is pushed through the propulsion tube into the shower head.

Accordingly, it is an object of the present invention to provide a cleaning liquid dispensing apparatus which allows a cleaning liquid to be inserted into a shower stream with a manual pump.

It is a further object of the present invention to provide a cleaning liquid dispensing apparatus which has a container that may be mounted at a level low enough to allow a child to operate thereof.

Finally, it is another object of the present invention to provide a cleaning liquid dispensing apparatus that is less complicated than that of the prior art.

These and additional objects, advantages, features and benefits of the present invention will become apparent from the following specification.

### BRIEF DESCRIPTION OF THE DRAWINGS

FIG. 1 is a perspective overview of a cleaning liquid dispensing apparatus for a shower head in accordance with the present invention.

FIG. 2a is a cross-sectional view of a 3-way connector of a cleaning liquid dispensing apparatus attached to a shower head in accordance with the present invention.

FIG. 2b is a cross-sectional view of a 3-way connector of a cleaning liquid dispensing apparatus attached to a shower head with more than one container having a pump in accordance with the present invention.

FIG. 3 is a perspective view of a container having a pump of a cleaning liquid dispensing apparatus in accordance with the present invention.

FIG. 4 is a cross sectional view of a container having a pump of a cleaning liquid dispensing apparatus in accordance with the present invention.

FIG. 5 is a bottom view of a container having a pump of a cleaning liquid dispensing apparatus in accordance with the present invention.

FIG. 6a is a top view of bottle retaining bracket of a container having a pump of a cleaning liquid dispensing apparatus in accordance with the present invention.

FIG. 6b is a side view of bottle retaining bracket of a container having a pump of a cleaning liquid dispensing apparatus in accordance with the present invention.

FIG. 7 is a front partially exploded view of a second embodiment of a container having a pump of a cleaning liquid dispensing apparatus in accordance with the present invention.

FIG. 8 is a cross sectional view of a second embodiment of a container having a pump of a cleaning liquid dispensing apparatus in accordance with the present invention.

### DETAILED DESCRIPTION OF THE PREFERRED EMBODIMENTS

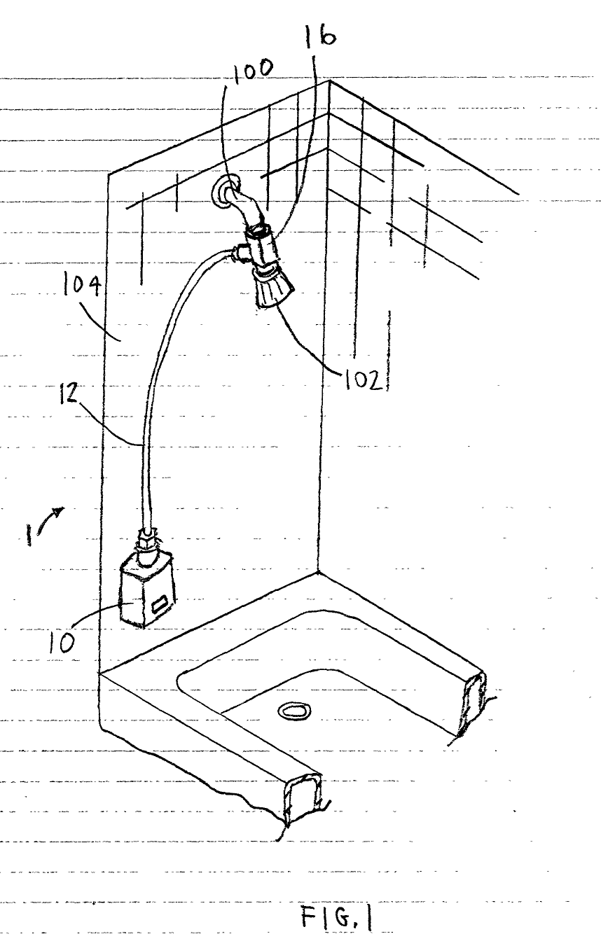

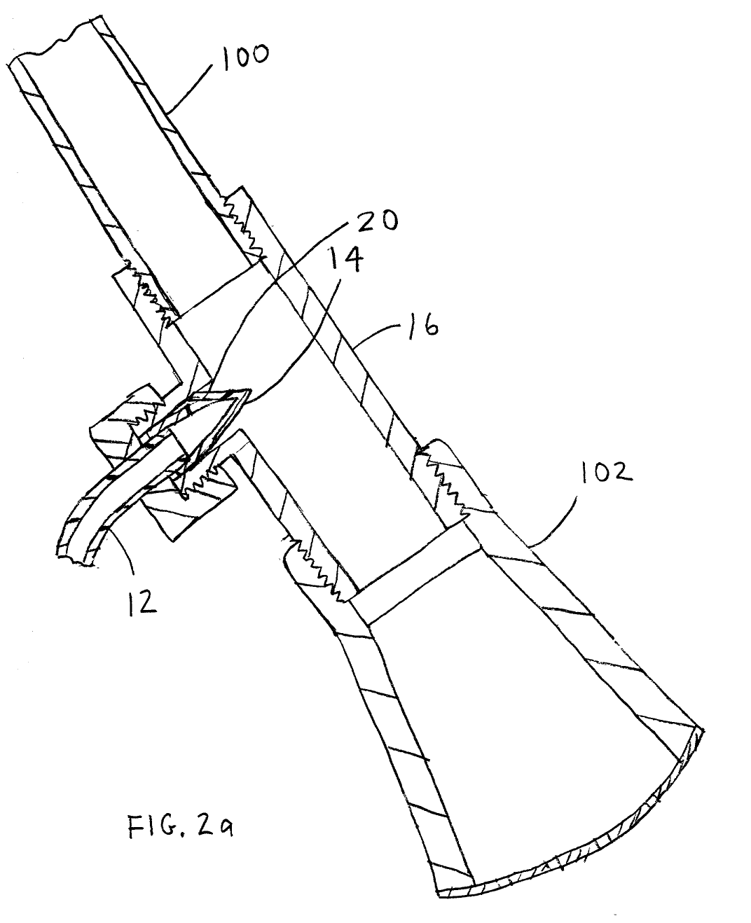

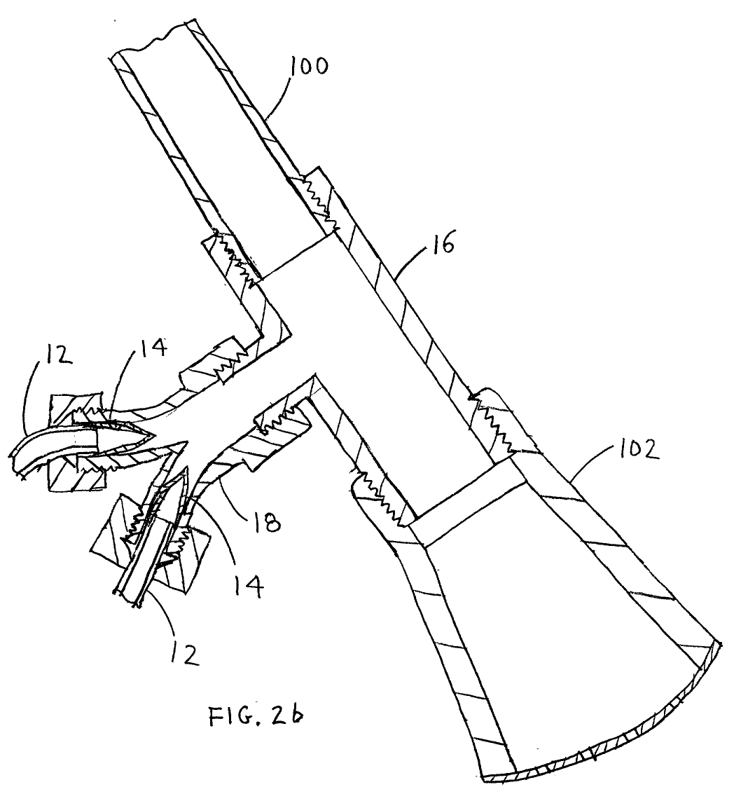

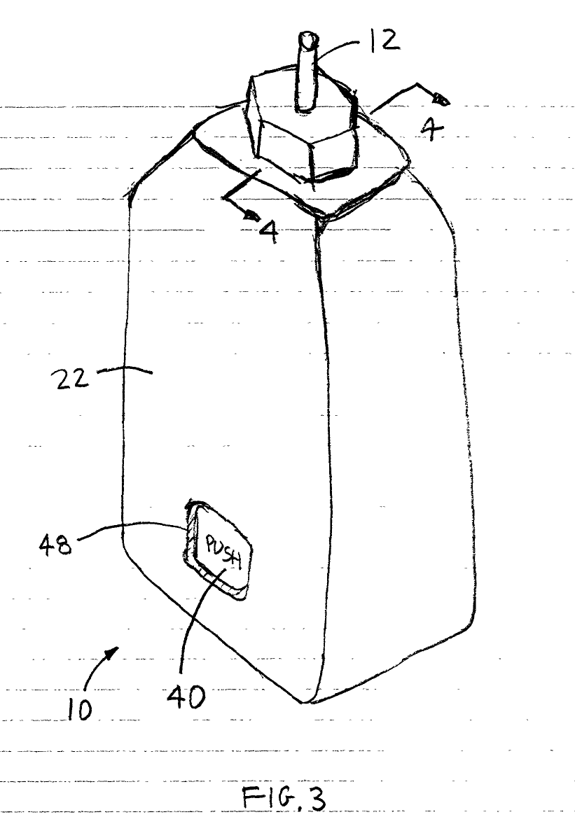

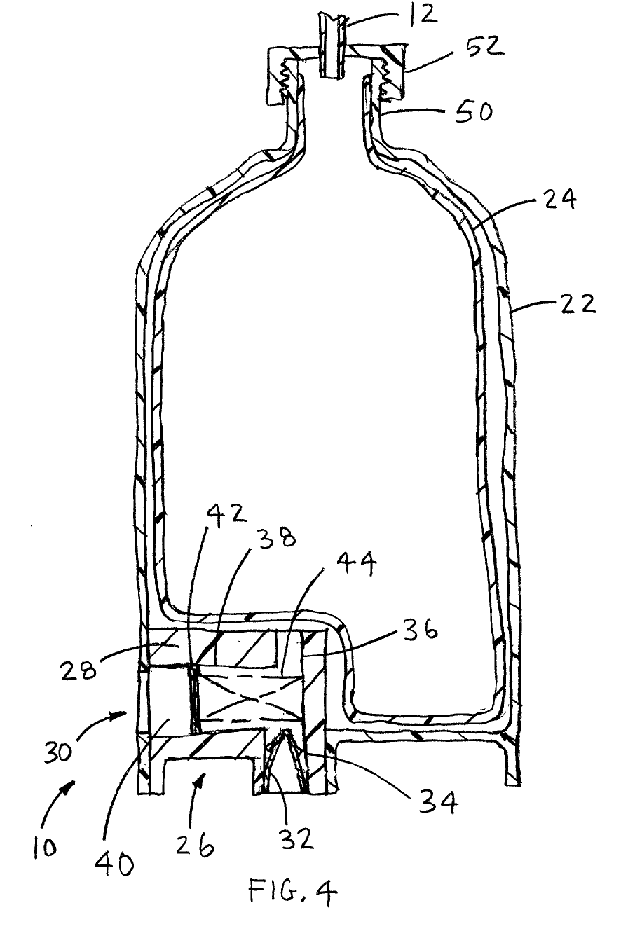

With reference now to the drawings, and particularly to FIG. 1, there is shown a perspective view of a cleaning liquid dispensing apparatus for a shower head 1. With reference to FIGS. 2a-4, the cleaning liquid dispensing apparatus 1 includes at least one container having a pump 10, a fluid line 12, a check valve 14, and a 3-way connector 16. One end of the 3-way connector 16 is sized to be threadably received by a shower head pipe 100, an opposing end is sized to be threadably received by a shower head 102, and a remaining end is sized to be attached to one end of a fluid line 12 or one end of a splitter connector 18. A check valve 14 terminates the one end of the fluid line 12. At least one valve 20 of the check valve 14 allows soap to be injected into the stream of water, but does not allow water to enter the fluid line 12. One design of check valve is shown, but other suitable designs of check valves may also be used. If a single container having a pump 10 is used, then the other end of the fluid line 12 is attached to the container having a pump 10. If more than one container having a pump 10 is used, then the other ends of the splitter connector 18 are each attached to one end of a single fluid line 12. The other end of each fluid line 12 is attached to a single container having a pump 10.

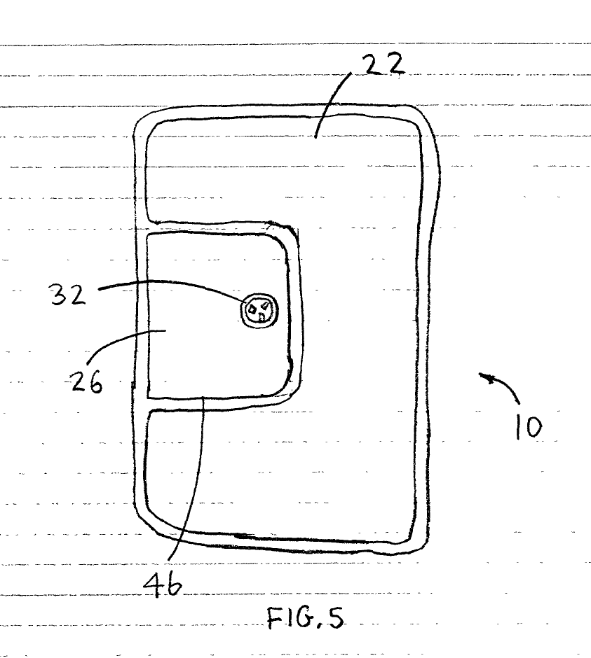

With reference to FIG. 5, each container having a pump 10 preferably includes a bottle 22, a fluid bag 24, and a manual pump 26. The manual pump 26 includes a pump body 28, a push button assembly 30, and a check valve 32. The pump body 28 includes an inlet 341 outlet 36, and button chamber 38. The check valve 32 is attached to the inlet 34 to prevent air from escaping the pump body 28. The push button assembly 30 is inserted into the button chamber 38. The push button assembly 30 includes a push button 40, a sealing gasket 42, and a compression spring 44. The sealing gasket 38 is attached to a back of the push button 40 and seals the button chamber 38 from the outside environment. When the push button 40 is depressed, air is forced into the bottle 22. After the push button 40 is depressed, the compression spring 44 forces thereof back which causes air to be pulled in from the outside environment.

The bottle 22 is formed with a pump opening 46 on a bottom thereof to receive the manual pump 26. An air tight seal is formed between the junction of the manual pump 26 and the pump opening 46 to prevent air from escaping an inside of the bottle 22. A button opening 48 is formed through a side of the bottle 22 to allow a finger to actuate the push button 40. The fluid bag 24 is preferably inserted through the pump opening 46 and a top of the fluid bag 24 is attached to an inside of a neck 50 in the bottle 22. The fluid bag 24 is filled with a cleaning liquid such as soap or shampoo. The fluid bag 24 is contained within the bottle 22. To inject the cleaning liquid or the like into the shower stream, the push button 40 of the push button assembly 30 is actuated several times until a bottom of the bottle 22 is filled with air. The air on the bottom of the bottle displaces the cleaning liquid in the fluid bag 24 through the fluid line 12 and into the water stream of the shower head. The fluid line 12 is preferably attached to the bottle with a cap 52. The cap 52 may be releasably attachable with any suitable method such as threads or a snap fit.

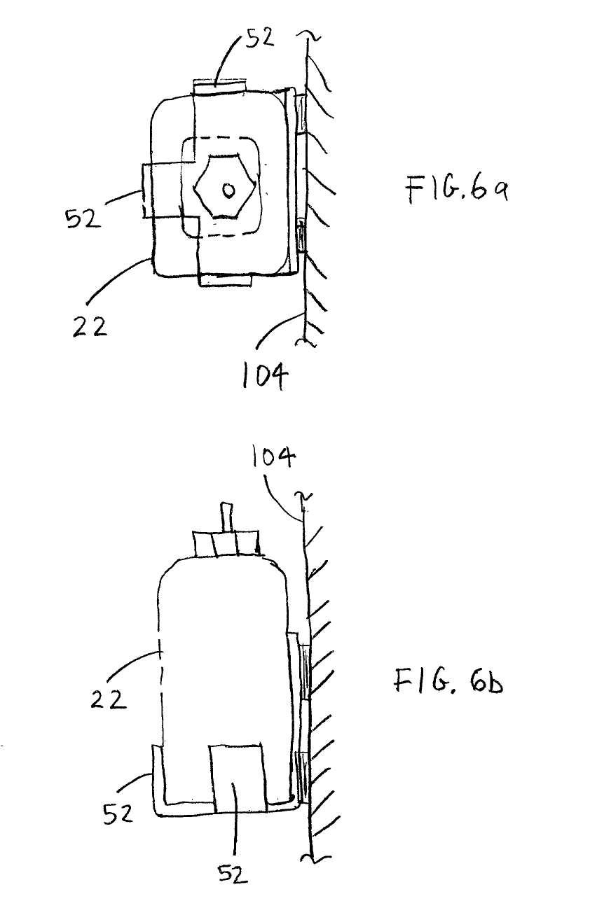

With reference to FIGS. 6a and 6b, the bottle 22 is retained against a shower wall 104 with a bottle retention bracket 50. The bottle retention bracket 50 is attached to the shower wall 104 with double sided tape, suction cups or any other suitable attachment method. The bottle retention bracket 50 has three upright fingers 52 which are spaced apart to retain the bottle 22. A set of suction cups may also be attached to a back of the bottle 22 for removably mounting thereof to a shower wall 104.

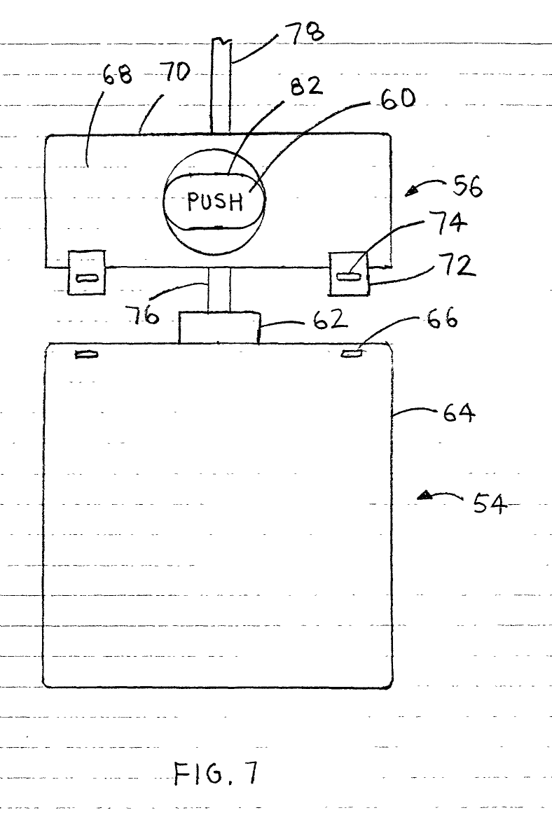

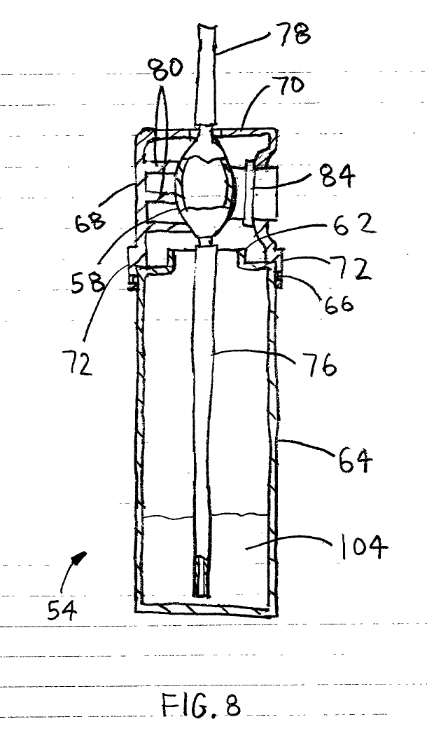

With reference to FIGS. 7 and 8, a second embodiment of a container having a pump 11 preferably includes a bottle 54, a cap 56, a bulb pump 58, and a push button 60. The bottle 54 includes a neck 62 and a body 64. The neck 62 is hollow to allow the body to be filled with soap, shampoo, or any other liquid. The cap 56 preferably includes four walls 68 terminated by a top 70. The bottle 54 and the cap 56 are shown as having a rectangular shape, but other shapes may also be used. Preferably, at least two snap tabs 72 extend downward from two of the walls 68. A projection slot 74 is formed through each snap tab 72. Preferably, at least two projections 66 are formed on the body 64 at substantially a top thereof. Each projection 66 is sized to be received by a single projection slot 74. Other methods of attaching the cap 56 to the bottle 54 may also be used.

A suction tube 76 is attached to one end of the bulb pump 58 and a propulsion tube 78 is disposed on the other end thereof. A hole is formed in the top 70 of the cap 56 to provide clearance for the propulsion tube 78. A set of bulb projections 80 are formed on an inside of one of the walls 68 of the cap 54. A button slot 82 is formed through a wall 68 opposite the bulb projections 80. The button slot 82 is sized to receive the push button 60. A retention flange 84 is preferably formed around the perimeter of the push button 60. Retention flange 84 prevents the push button from falling out of the button slot 82. The bulb pump 58 is retained between the push button 60 and the bulb projections 80.

When the push button 60 is actuated against the pump bulb 58, the pump bulb 58 is compressed and draws a quantity of liquid 104 from a bottom of the bottle 54 through the suction tube 76. The quantity of liquid 104 is pushed through the propulsion tube 78 into the shower head 1.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A cleaning liquid dispensing apparatus for a shower head comprising:
a 3-way connector is attached to a shower head pipe, an opposing end is attached to a shower head, and a remaining end is attached to one end of a fluid line; and
a container including a bottle, a cap, a bulb pump, and a push button, said bulb pump being retained in said cap, said push button capable of being actuated to compress said bulb pump, a suction tube drawing a quantity of liquid from a bottom of said bottle and pushing thereof through a propulsion tube into a shower stream by actuating said push button.

2. The cleaning liquid dispensing apparatus for a shower head of claim 1, wherein:
a check valve being disposed in said remaining end of said 3-way connector, said check valve preventing water from entering said container.

3. The cleaning liquid dispensing apparatus for a shower head of claim 1, wherein:
a splitter connector being attached to a remaining end of said 3-way connector;
a second container being connected to a second fluid line; and
one end of said fluid line being attached to another end of said splitter connector, said second fluid line being attached to a remaining end of said splitter.

4. The cleaning liquid dispensing apparatus for a shower head of claim 3, wherein:
a check valve terminating an end of said fluid line and a second check valve terminating an end of said second fluid line.

5. A cleaning liquid dispensing apparatus for a shower head comprising:
a 3-way connector is attached to a shower head pipe, an opposing end is attached to a shower head, and a remaining end is attached to one end of a fluid line; and
a container having a pump, said container being filled with a cleaning liquid, said pump of said container being actuated to inject the cleaning liquid into a shower stream.

6. The cleaning liquid dispensing apparatus for a shower head of claim 5, wherein:
a check valve being disposed in said remaining end of said 3-way connector, said check valve preventing water from entering said container.

7. The cleaning liquid dispensing apparatus for a shower head of claim 5, further comprising:
said container including a bottle, a cap, a bulb pump, and a push button, said cap capable of being attached to said bottle, a bulb pump being retained in said cap, said push button capable of being actuated to compress said bulb pump, a suction tube drawing a quantity of liquid from a bottom of said bottle and pushing thereof through a propulsion tube into a stream of water in the shower head.

8. The cleaning liquid dispensing apparatus for a shower head of claim 5, further comprising:
said container including a bottle, a fluid bag, and said pump, said fluid bag being contained within said bottle, said pump being capable of filling said bottle with air, the air forcing the cleaning liquid in said fluid bag to be injected into the stream of water in the shower head.

9. The cleaning liquid dispensing apparatus for a shower head of claim 7, wherein:
a splitter connector being attached to a remaining end of said 3-way connector;
a second fluid bag being connected to a second fluid line; and
one end of said fluid line being attached to another end of said splitter connector, said second fluid line being attached to a remaining end of said splitter.

10. The cleaning liquid dispensing apparatus for a shower head of claim 9, wherein:
a check valve terminating an end of said fluid line and a second check valve terminating an end of said second fluid line.

11. The cleaning liquid dispensing apparatus for a shower head of claim 8, wherein:
a splitter connector being attached to a remaining end of said 3-way connector;
a second fluid bag being connected to a second fluid line; and
one end of said fluid line being attached to another end of said splitter connector, said second fluid line being attached to a remaining end of said splitter.

12. The cleaning liquid dispensing apparatus for a shower head of claim 11, wherein:
a check valve terminating an end of said fluid line and a second check valve terminating an end of said second fluid line.

13. A cleaning liquid dispensing apparatus for a shower head comprising:
a 3-way connector being attached to a shower head pipe, an opposing end is attached to a shower head, and a remaining end is attached to one end of at least one fluid line; and
at least one container having a pump, each said container being filled with a cleaning liquid, said pump of each said container being actuated to inject the cleaning liquid into a stream of water in the shower head.

14. The cleaning liquid dispensing apparatus for a shower head of claim 13, wherein:
a check valve being disposed in said remaining end of said 3-way connector, said check valve preventing water from entering said container.

15. The cleaning liquid dispensing apparatus for a shower head of claim 13, further comprising:
a container including a bottle, a cap, a bulb pump, and a push button, said cap capable of being attached to said bottle, a bulb pump being retained in said cap, said push button capable of being actuated to compress said bulb pump, a suction tube drawing a quantity of liquid from a bottom of said bottle and pushing thereof through a propulsion tube into a stream of water in the shower head.

16. The cleaning liquid dispensing apparatus for a shower head of claim 13, further comprising:
each said container including a bottle, a fluid bag, and said pump, said fluid bag being contained within said bottle, said pump being capable of filling said bottle with air, the air forcing the cleaning liquid in said fluid bag through a single said fluid line to be injected into the stream of water in the shower head.

17. The cleaning liquid dispensing apparatus for a shower head of claim 15, wherein:
a splitter connector being attached to a remaining end of said 3-way connector, each said fluid bag being connected to the one of the remaining ends of said 3-way connector through a single said fluid line.

18. The cleaning liquid dispensing apparatus for a shower head of claim 17, wherein:
a check valve terminating an end of said fluid line and a second check valve terminating an end of said second fluid line.

19. The cleaning liquid dispensing apparatus for a shower head of claim 16, wherein:
a splitter connector being attached to a remaining end of said 3-way connector, each said fluid bag being connected to the one of the remaining ends of said 3-way connector through a single said fluid line.

20. The cleaning liquid dispensing apparatus for a shower head of claim 19, wherein:
a check valve terminating an end of said fluid line and a second check valve terminating an end of said second fluid line.
